(19) United States
(12) Patent Application Publication
(10) Pub. No.: US 2024/0081185 A1
(43) Pub. Date: Mar. 14, 2024

(54) FOLDING LINE DIVIDER FOR A HARVESTING PLATFORM

(71) Applicant: CNH Industrial America LLC, New Holland, PA (US)

(72) Inventors: Nicholas Stephen Shane, II, Rock Island, IL (US); Daniel Christopher Dallman, Eldridge, IA (US); Daenio Cleodolphi, Piracicaba (BR); Marco Aurelio Ramos Pereíra, Piracicaba (BR)

(21) Appl. No.: 18/274,643

(22) PCT Filed: Jan. 27, 2022
(86) PCT No.: PCT/US22/14066

§ 371 Date: Jul. 27, 2023

Related U.S. Application Data
(60) Provisional application No. 63/142,274, filed on Jan. 27, 2021.

(51) Int. Cl. A01D 63/02; A01D 45/10

(52) U.S. Cl. CPC A01D 63/02; A01D 45/10; A01D 69/00

(57) ABSTRACT

A cutting and harvesting assembly for an agricultural machine includes a structural frame. A central portion divider set is operably coupled with the structural frame and includes one or more central portion feed rollers. A first line divider set is laterally offset from the central portion divider set. The first line divider set includes a first pivoting frame, a first connection element operably coupled to the first pivoting frame and the structural frame, one or more first set feed rollers operably coupled with the first pivoting frame. A second line divider set is positioned on an opposing side of the central portion divider set from the first line divider set. The second line divider set includes a second pivoting frame, a second connection element operably coupled to the second pivoting frame and the structural frame, and one or more second set feed rollers operably coupled with the second pivoting frame.

### CROSS-REFERENCE TO RELATED APPLICATION

This application claims the benefit of priority to U.S. Provisional Patent Application No. 63/142,274, filed on Jan. 27, 2021, the disclosure of which is hereby incorporated by reference herein in its entirety for all purposes.

### FIELD

The present disclosure generally relates to a cutting and harvesting assembly for agricultural machines, in particular for the harvesting of tall and stalky plants.

### BACKGROUND

Several models of agricultural machines and equipment are developed to increase productivity in the harvesting of numerous types of crops. For example, some agricultural machines may be configured for use with so-called tall and stalky plants, such as sugarcane and sweet sorghum. The machines particularly intended for the harvesting of tall and stalky plants are designed and developed to promote the harvesting of this specific type of crop because their intrinsic characteristics require proper conditions for the adequate processing thereof, from cutting to transfer to transshipments and/or trucks.

The machines intended for the harvesting the tall and stalky crops include a chassis designed to support a series of components and mechanisms responsible for cutting, harvesting, conducting, and chopping the cane and/or sorghum into billets, which are then transferred to the transshipments and/or cane and/or sorghum trucks through a lift assembly. Furthermore, this type of agricultural machine has a cutting and harvesting assembly that comprises a number of components, such as line dividers, tipping rollers, base cutting discs, and lift rollers.

In some instances, the cutting and harvesting assembly may be disassembled from the machine to reduce its width and allow the transport thereof within the legal limits. However, the disassembly of these components is not a simple and fast task, requiring tools and technicians with experience to perform these services that, in the end, entail the expenditure of time and efforts which reflect on the costs and productivity of the crops. Accordingly, an improved cutting and harvesting assembly for an agricultural machine and method for operating the cutting and harvesting assembly for the agricultural machine would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a cutting and harvesting assembly for an agricultural machine. The assembly includes a structural frame. A central portion divider set is operably coupled with the structural frame and includes one or more central portion feed rollers. A first line divider set is laterally offset from the central portion divider set and is operably coupled with the structural frame. The first line divider set includes a first pivoting frame, a first connection element operably coupled to the first pivoting frame and the structural frame, one or more first set feed rollers operably coupled with the first pivoting frame. A second line divider set is positioned on an opposing side of the central portion divider set from the first line divider set and is operably coupled with the structural frame. The second line divider set includes a second pivoting frame, a second connection element operably coupled to the second pivoting frame and the structural frame, and one or more second set feed rollers operably coupled with the second pivoting frame.

In some aspects, the present subject matter is directed to a cutting and harvesting assembly for an agricultural machine. The assembly includes a structural frame. A line divider set is operably coupled with the structural frame. The line divider set includes pivoting frame, a connection element operably coupled to the pivoting frame and the structural frame, the connection element configured to maintain the pivoting frame in a first position and a second position, a first feed roller operably coupled with the pivoting frame, and a second feed roller separated from the first pivoting frame and operably coupled with the structural frame. The first feed roller is a first distance from the second roller when the pivoting frame is in the first position and the second feed roller is a second, smaller distance from the second roller when the pivoting frame is in the second position.

In some aspects, the present subject matter is directed to a method for operating a cutting and harvesting assembly for an agricultural machine. The method includes releasing a first locking element from a first connection element, wherein the first connection element operably couples a first pivoting frame of the harvesting assembly to a structural frame of the harvesting assembly. The method also includes rotating the first pivoting frame and one or more feed rollers operably coupled with the first pivoting frame from a first position to a second position.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a schematic side view of a harvester machine for the harvesting of tall and stalky vegetable crops, such as sugarcane and sorghum, in accordance with aspects of the present subject matter;

FIG. 2 is an isolated perspective view of the cutting and harvesting assembly of a sugarcane and/or sorghum agricultural machine in accordance with aspects of the present subject matter;

FIG. 3 is a front view of the cutting and harvesting assembly of a harvester machine with the line divider sets in the working or open position in accordance with aspects of the present subject matter;

FIGS. 4A and 4B are front and top views of the cutting and harvesting assembly represented in FIG. 3 with one of the line divider sets pivoted in accordance with aspects of the present subject matter;

FIGS. 5A and 5B are respective front and top views of the cutting and harvesting assembly represented in FIG. 3 with the two end line divider sets pivoted in accordance with aspects of the present subject matter;

FIGS. 6A and 6B are respective top and bottom views of one of the pivoted line divider sets in accordance with aspects of the present subject matter;

FIGS. 7A and 7B are internal side views of one of the line divider sets in the working or open position, and in the transport or pivoted position, respectively, in accordance with aspects of the present subject matter;

FIGS. 8A and 8B are front views of one of the line divider sets in the working or open position, and in the transport or pivoted position, respectively, in accordance with aspects of the present subject matter;

FIGS. 9A and 9B are external side views of one of the line divider sets in the working or open position, and in the transport or pivoted position, respectively, in accordance with aspects of the present subject matter;

FIG. 10 is a side perspective view of the first line divider set in a first position in accordance with aspects of the present subject matter;

FIG. 11 is a side perspective view of the first line divider set in a second position in accordance with aspects of the present subject matter;

FIG. 12 is a rear perspective view of the first line divider set in the second position in accordance with aspects of the present subject matter;

FIG. 13 is an enhanced view of area XIII of FIG. 10;

FIG. 14 is a bottom perspective view of the first line divider set in the second position in accordance with aspects of the present subject matter;

FIG. 15 is a top perspective view of the first line divider set in the first position in accordance with aspects of the present subject matter;

FIG. 16 is a side perspective view of the first line divider set in the second position in accordance with aspects of the present subject matter;

FIG. 17 is a rear perspective view of a structural frame and the first line divider set in accordance with aspects of the present subject matter; and

FIG. 18 illustrates a flow diagram of a method for operating a cutting and harvesting assembly for an agricultural machine in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product through a system. For example, “upstream” refers to the direction from which an agricultural product moves and “downstream” refers to the direction to which the agricultural product moves. The term “selectively” refers to a component's ability to operate in various states (e.g., an ON state and an OFF state) based on manual and/or automatic control of the component.

The terms “fore” and “aft” refer to relative positions along the agricultural machine relative to a fore-aft axis. The fore direction is a direction along the fore-aft axis that may also be referred to as a forward motion direction of the machine. In addition, an aft direction along the fore-aft is a direction along the fore-aft axis that may also be referred to as a rearward motion direction of the machine. A lateral direction may be defined by a transverse axis that extends between a right side and a left side of the machine and may be perpendicular to the fore-aft axis. As such, any component that is “laterally inward” of another component may be positioned in closer proximity to the fore-aft axis and any component that is “laterally outward” of another component may be positioned in closer proximity to the fore-aft axis along the transverse axis. A longitudinal direction may be defined as a third direction in a three-dimensional plane that is perpendicular to the fore-aft axis and the transverse axis. For example, the height of the machine may be defined in the longitudinal direction.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a cutting and harvesting assembly for an agricultural machine and a method for operating the cutting and harvesting assembly. The cutting and harvesting assembly provided herein may be formed by at least two sets of line dividers arranged along a structural frame. Each line divider set includes a respective pivoting frame. The cutting and harvesting assembly provided herein enables the width of agricultural machines of tall and stalky plants to be reduced without the need to disassemble the frontal components of the machine that restrict the circulation thereof on roads during transport. In addition, the cutting and harvesting assembly for the agricultural machine manages to simplify and optimize the transport process of the agricultural machine and, thereby, obtain practical logistics results that may ultimately provide significant results in productivity in the harvesting processes, in view of the time and effort required to put these machines into operation in the fields.

In some examples, the cutting and harvesting assembly includes a structural frame that may be operably coupled with a chassis of an agricultural machine and/or form part of the chassis of the agricultural machine. A central portion divider set is operably coupled with the structural frame and includes one or more central portion feed rollers.

A first line divider set is laterally offset from the central portion divider set and is operably coupled with the structural frame. The first line divider set includes a first pivoting frame. A first connection element is operably coupled to the first pivoting frame and the structural frame. One or more first set feed rollers is operably coupled with the first pivoting frame.

A second line divider set is positioned on an opposing side of the central portion divider set from the first line divider set and is operably coupled with the structural frame. The second line divider set includes a second pivoting frame. A second connection element is operably coupled to the second pivoting frame and the structural frame. One or more second set feed rollers is operably coupled with the second pivoting frame.

The first line divider set and/or the second line divider set are movable between a first position and a second position, which allows for the total width of the cutting and harvesting assembly to be reduced. As used herein, the total width of the cutting and harvesting assembly may be defined by a distance between the first line divider set and the second line divider in a lateral direction.

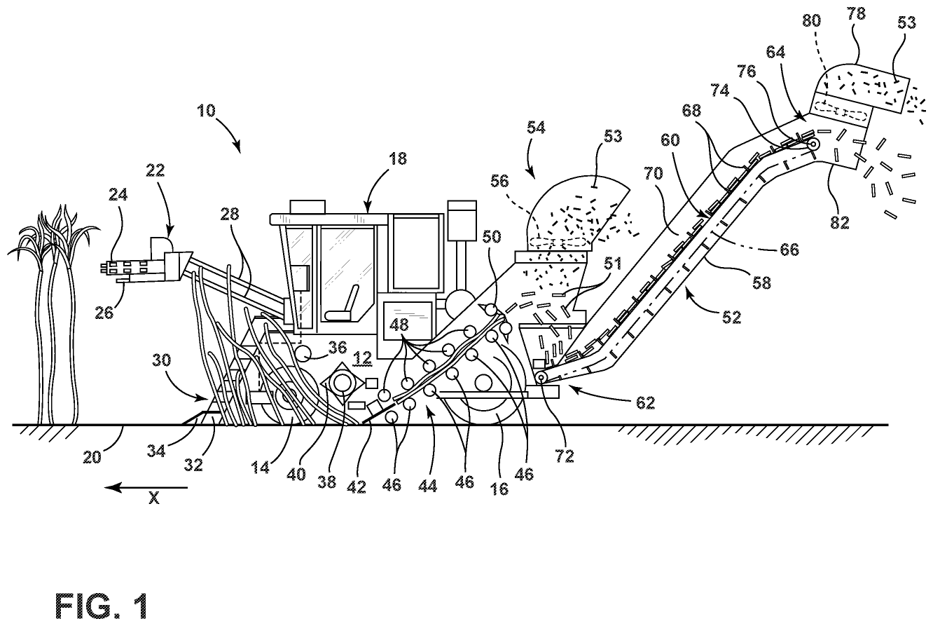

Referring now to FIG. 1, a side view of an agricultural machine 10 is illustrated in accordance with various aspects of the present disclosure. As illustrated, the agricultural machine 10 is configured as a sugarcane harvester. However, in other examples, the agricultural machine 10 can correspond to any suitable agricultural harvester without departing from the scope of the present disclosure.

As shown in FIG. 1, the agricultural machine 10 includes a chassis 12, a pair of front wheels 14, a pair of rear wheels 16, and an operator cab 18. The agricultural machine 10 may also include a primary power source (e.g. an engine mounted on the chassis 12) that energizes one or both pairs of wheels 14, 16 through a transmission. Alternatively, the agricultural machine 10 can be a harvester driven on belts and therefore may include belts driven by the primary power source in place of the illustrated wheels 14, 16. The primary power source can also drive a hydraulic fluid pump arranged to generate pressurized hydraulic fluid to drive various hydraulic components of the agricultural machine 10.

Additionally, the agricultural machine 10 can include various components for cutting, processing, cleaning, and unloading sugarcane as the cane is harvested from an agricultural field 20. For example, the agricultural machine 10 may include a tip cutter assembly 22 positioned at its front end to intercept sugarcane as the agricultural machine 10 is moved in the forward direction represented by arrow X. As shown, the tip cutter assembly 22 can include both a binder disc 24 and a cutter disc 26. The binder disc 24 can be arranged to gather crop stalks so that the cutter disc 26 can be used to cut the tip of each stalk. In various examples, the height of the tip cutter assembly 22 can be adjustable by a pair of arms 28, which may be hydraulically raised and lowered.

Additionally, the agricultural machine 10 may include a harvesting assembly 100 that can include one or more line divider sets 30 that extend up and back from the field 20. In general, the one or more line divider sets 30 can include spiral feed rollers 32, each of which may also be known as a “lollipop.” Each feed roller 32 can include a ground plate 34 since its lower end assists the one or more line divider sets 30 by dividing the crop stalks for harvesting. In addition, as shown in FIG. 1, the agricultural machine 10 may include a tipping roller 36 positioned near the front wheels 14 and a roll with projections 38 positioned behind the tipping roller 36. As the tipping roller 36 is rotated, the harvested crop stalks are tipped while the line divider set 30 gathers the stalks from the agricultural field 20 towards the inside of the machine 10. Additionally, as shown in FIG. 1, the roll with projections 38 may include a plurality of intermittently mounted fins 40 that assist in forcing the crop stalks down. As the roll 38 is rotated during harvest, the crop stalks that have been tipped by the tipping roller 36 are separated and subsequently tipped by the roll 38 as the agricultural machine 10 continues to be moved forward with respect to the field 20.

With further reference to FIG. 1, the agricultural machine 10 can also include a base cutting set 42 positioned behind the roll 38. In general, the base cutting set 42 may include blades for cutting the crop stalks as the cane is harvested. The blades, located on the periphery of the base cutting set 42, can be rotated by a hydraulic motor driven, for example, by the vehicle's hydraulic system. Additionally, in several embodiments, the blades can be angled down to cut the base of the sugarcane as the cane is tipped by the roll 38.

As will be appreciated by persons skilled in the art, these components and mechanisms, which may form the cutting and harvesting assembly 100 of the machine 10, can be mounted directly on the structure of the chassis 12, or also on an independent front platform thereby allowing the exchange and replacement of these elements for the proper adequacy and configuration of the machine 10 to the specificities of the crop that is intended to be harvested in the field 20.

In addition, the agricultural machine 10 can include a set of one or more conveyor rollers 44 located downstream of the base cutting set 42 to move the cut crop stalks from the base cutting set 42 along the processing path. As shown in FIG. 1, the conveyor roller assembly 44 can include a plurality of lower rollers 46 and a plurality of upper rollers 48. As sugarcane is transported through the conveyor roller assembly 44, waste (e.g. stones, dirt, and/or the like) can also be transported or fall through the lower rollers 46 onto the field 20.

Additionally, the agricultural machine 10 may include a chipper set 50 located at the downstream end of the transport roller assembly 44 (e.g. adjacent to the rearmost lower and upper rollers 46, 48). In general, the chipper set 50 can be used to cut or chop the harvested crop stalks into smaller pieces or “fragments” 51 that can, for example, measure 15.24 centimeters (six inches), and may also be referred to as billets. The fragments 51 can then be propelled in the direction of a lift assembly 52 of the agricultural machine 10 to be collected on an external receiver or storage device.

In general, pieces of waste 53 (e.g. dust, subject, leaves, etc.) separated from the sugarcane the fragments 51 can be expelled from the agricultural machine 10 through a primary waste extractor set 54, which is located behind the chipper set 50 and is oriented to direct waste 53 out of the agricultural machine 10. Additionally, a fan 56 can be mounted on the primary extractor 54 to generate a suction force or vacuum sufficient to capture the waste 53 and force the waste 53 through the primary extractor 54. The waste 53 is then directed out and usually in the opposite direction of the agricultural machine 10 by through an outlet of the primary extractor 54. The fragments 51 that are separated and heavier than the waste 53 being expelled from the extractor 54, can then fall into the lift assembly 52.

As shown in FIG. 1, the lift assembly 52 may generally include a lift housing 58 and a lift 60 that extends into the lift housing 58 between a lower proximal end 62 and an upper distal end 64. In general, the lift 60 may include a chain or conveyor belt 66 and a plurality of paddles or protrusions 68 coupled or evenly spaced in the chain 66. The protrusions 68 can be arranged to hold the sugarcane the fragments 51 in the lift 60 as the fragments 51 are raised towards the top of the lift 70. Additionally, the lift 60 can include lower and upper sprockets 72, 74 positioned around the proximal and distal extremities 62, 64, respectively. As shown in FIG. 1, a lift motor 76 can be coupled to one of the sprockets (e.g. the upper sprocket 74) to drive the chain 66, thus allowing the chain 66 and the protrusions 68 to move in an endless cycle between the proximal and distal extremities 62, 64 of the lift 60.

In addition, pieces of waste 53 (e.g. dust, dirt, leaves, etc.) separated from sugarcane the fragments 51 can be expelled from the agricultural machine 10 through a secondary waste extractor assembly 78 coupled to the rear end of the lift 58. As shown in FIG. 1, the secondary extractor assembly 78 can be located adjacent to the distal end 64 of lift 60 and can be oriented to direct the waste 53 out of the agricultural machine 10. Additionally, a fan 80 can be mounted on the secondary extractor 78 to generate a suction force or vacuum sufficient to extract the waste 53 and force the waste 53 through the secondary extractor 78. The fragments 51 that are separated and heavier than the waste 53 expelled through extractor 78, can then fall from the distal end 64 of the lift 60. Typically, the fragments 51 can fall through a discharge opening 82 of the lift assembly 52 into an external storage device, such as a car, transshipment, dumpster, etc.

During operation, the agricultural machine 10 is driven throughout the agricultural field 20 to harvest sugarcane. Once the height of the tip cutter 22 is adjusted (if used) by the arms 28, the binder disc 24 in the tip cutter assembly 22 can work in such a way as to clump the sugarcane tips as the agricultural machine 10 proceeds through the field 20, while the cutter disc 26 cuts the leafy tips of the crop stalks to discharge them along both sides of the agricultural machine 10. As the stalks enter the one or more line divider sets 30, the plates 34 can arrange the width of the operation to determine the amount of sugarcane entering an inlet opening of the agricultural machine 10, either fixedly or adjustably. The lollipops 32 then gather the stalks at the machine inlet to allow the tipping roller 36 to bend the stalks down together with the action of the roller with fins 38. Once the stalks are positioned at an angle, as shown in FIG. 1, the base cutting set 42 can then cut the base of the stalks from the field 20. The cut stalks are then directed to the conveyor roll assembly 44.

The cut stalks of sugarcane are transported backwards by the conveyor rolls 46, 48, which compress the stalks and harvested matter. At the downstream end of the conveyor roller assembly 44, the chipper set 50 cuts or chops the compacted crop stalks into pieces or the fragments 51. Waste transported 53 (e.g. dust, dirt, leaves, etc.) separated from sugarcane the fragments 51 are then extracted through the primary waste extractor assembly 54 using the suction or vacuum created by fan 56. The separated/washed the fragments 51 then fall to the lift assembly 52 and travel upward by way of the lift 60 from its proximal end 62 to the distal end 64. During normal operation, once the fragments 51 reach the distal end 64 of the lift 60, the fragments 51 fall through the discharge opening 82 to an external storage device. Similar to the primary extractor 54, waste is blown out of the agricultural machine 10 through the secondary waste extractor assembly 78 with the help of the fan 80.

Additionally, although the drawings represent a frontal structure arranged for the harvesting of two planting lines and, therefore, composed with the frontal elements in duplicate, as will be appreciated by persons skilled in the art, the cutting and harvesting assembly 100 can be arranged to perform the harvest in only one planting line or multiple planting lines, varying according to the interests of projects and market demands, without interfering with the scope of the present disclosure.

Also, although the figures represent the cutting and harvesting assembly 100 as an independent platform, as previously indicated, the cutting and harvesting assembly 100 can additionally or alternatively be mounted directly on the chassis 12 of the machine 10.

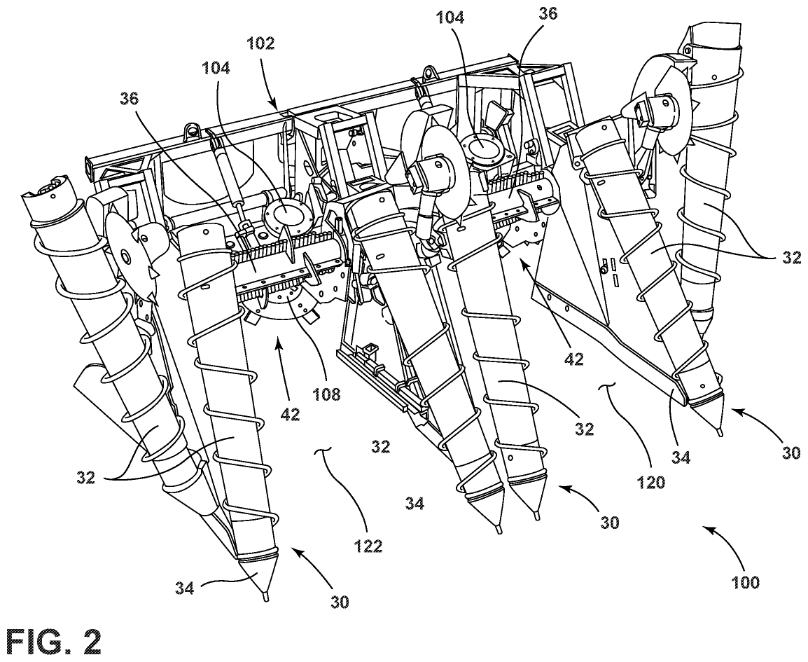

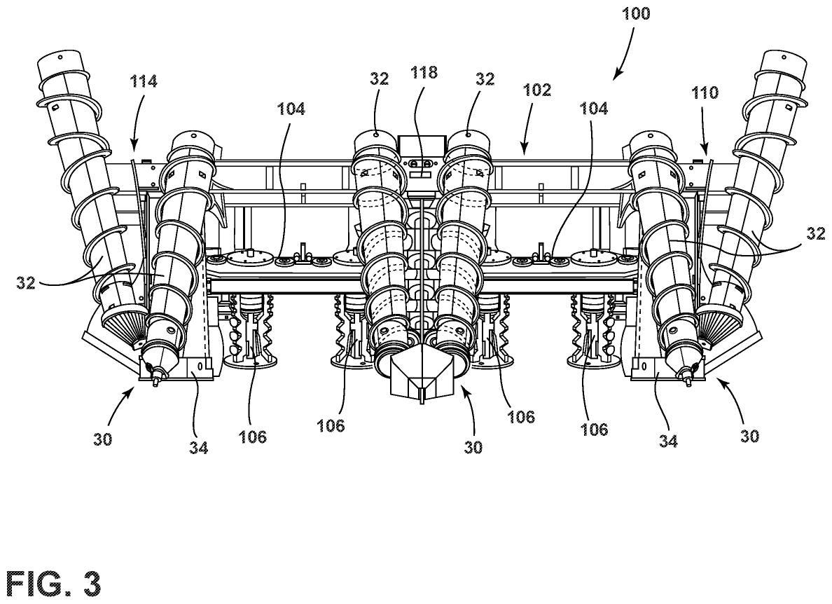

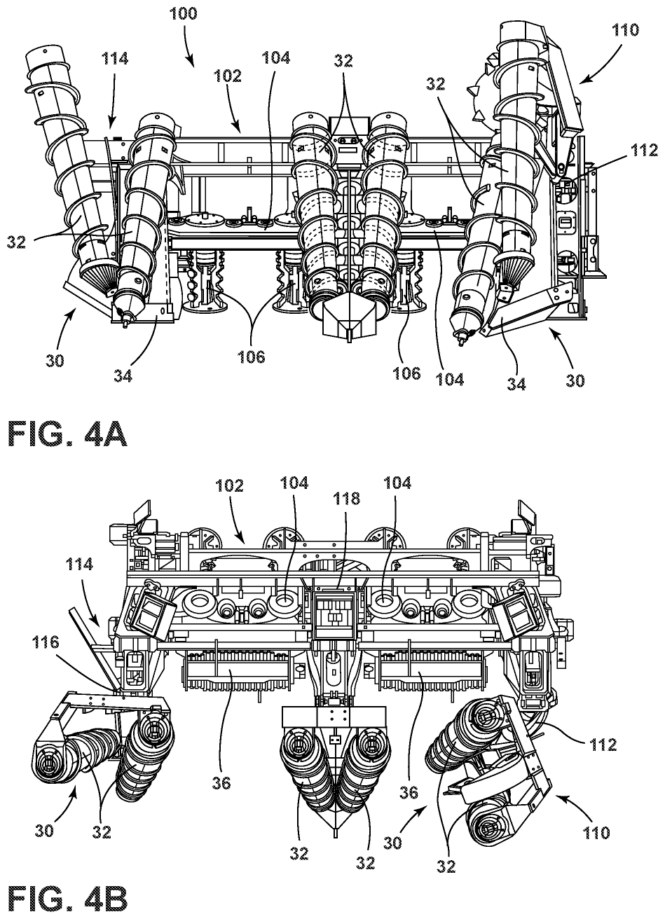

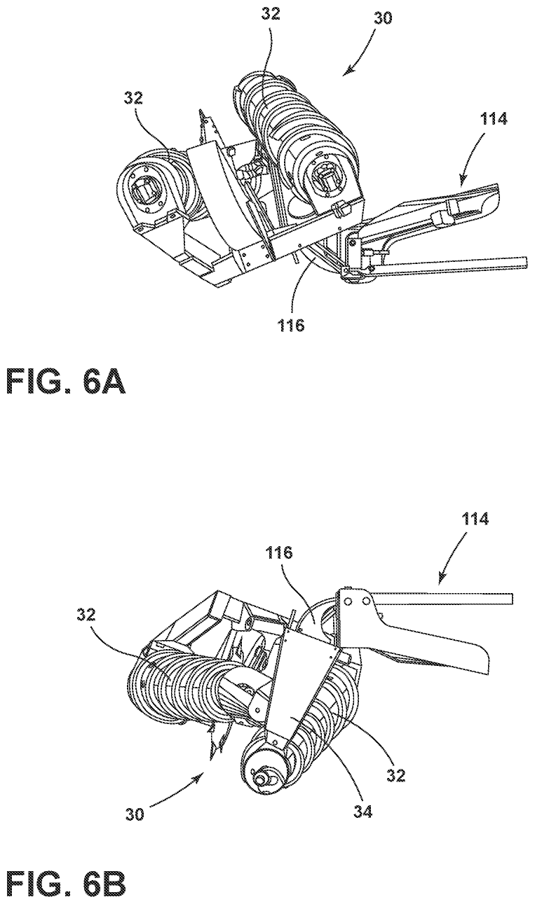

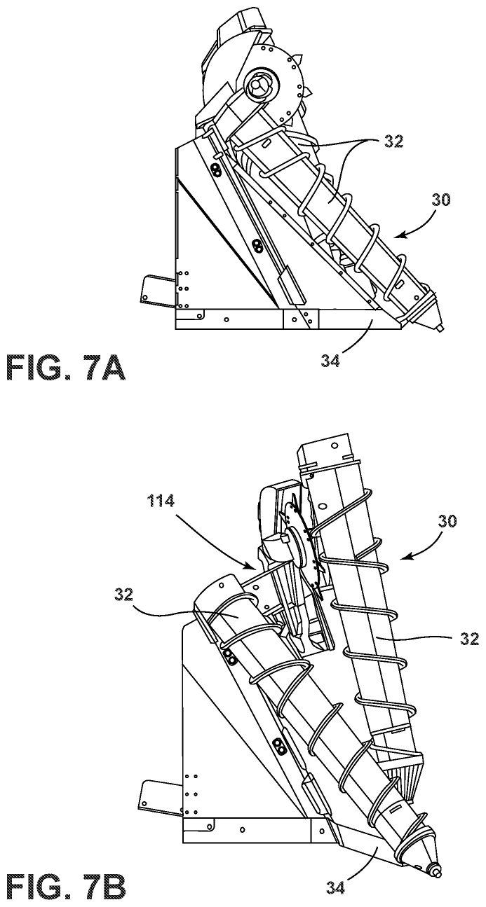

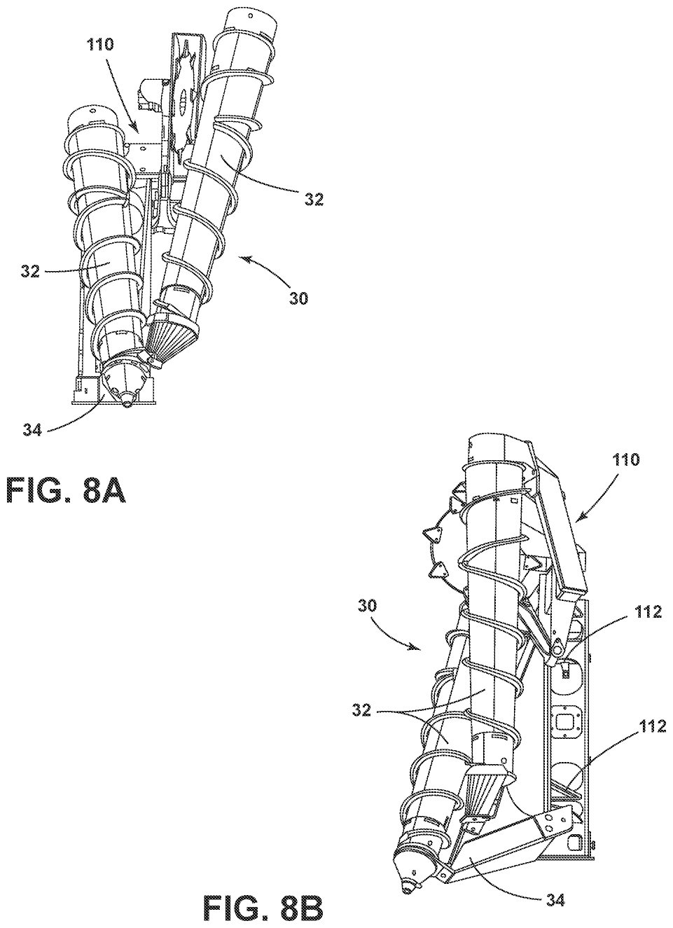

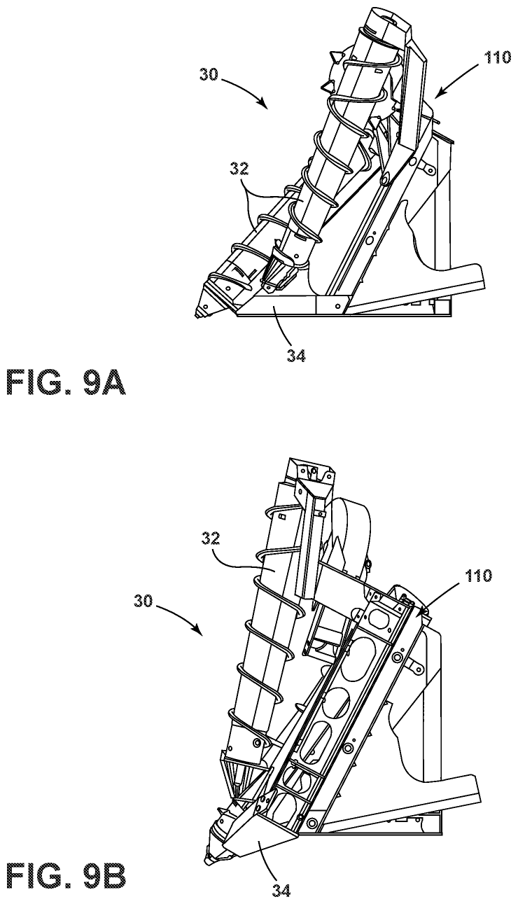

Referring now to FIGS. 2-9B, the cutting and harvesting assembly 100 is illustrated in accordance with various aspects of the present disclosure. As illustrated, the harvesting assembly 100 can include a structural frame 102 on which are installed the one or more line divider sets 30 for separation and direction of the crop stalks for harvesting. Furthermore, the cutting and harvesting assembly 100 can include at least one tipping roller 36 arranged upstream of the base cutting set 42, which is formed by a drive box 104 from which rotating shafts 106 are projected and whose ends support base cutting discs 108 provided with blades to cut the crop (e.g., sugarcane and/or sorghum) stalks as the harvest is carried out along the field 20.

In the examples illustrated in FIGS. 2-9B, the cutting and harvesting assembly 100 may be configured as a multi-row harvester, and accordingly, can include a central portion divider set 30, a first line divider set 30, and a second line divider set 30. In some examples, the central portion divider may include one or more central portion feed rollers 32 operably coupled with a central portion frame 118. The first line divider set 30 may include one or more feed rollers 32 and one or more plates 34 that are operably coupled with a first pivoting frame 110. Similarly, the second line divider set 30 may include one or more feed rollers 32 and one or more plates 34 that are operably coupled with a second pivoting frame 114.

In some instances, the first line divider set 30 includes a pair of feed rollers 32 operably coupled with the first pivoting frame 110. The pair of feed rollers 32 may be positioned laterally outward of the one or more central portion feed rollers 32. A first opening 120 may be defined between the one or more central portion feed rollers 32 and the feed rollers 32 operably coupled with the first pivoting frame 110 for separation and direction of the crop stalks for harvesting.

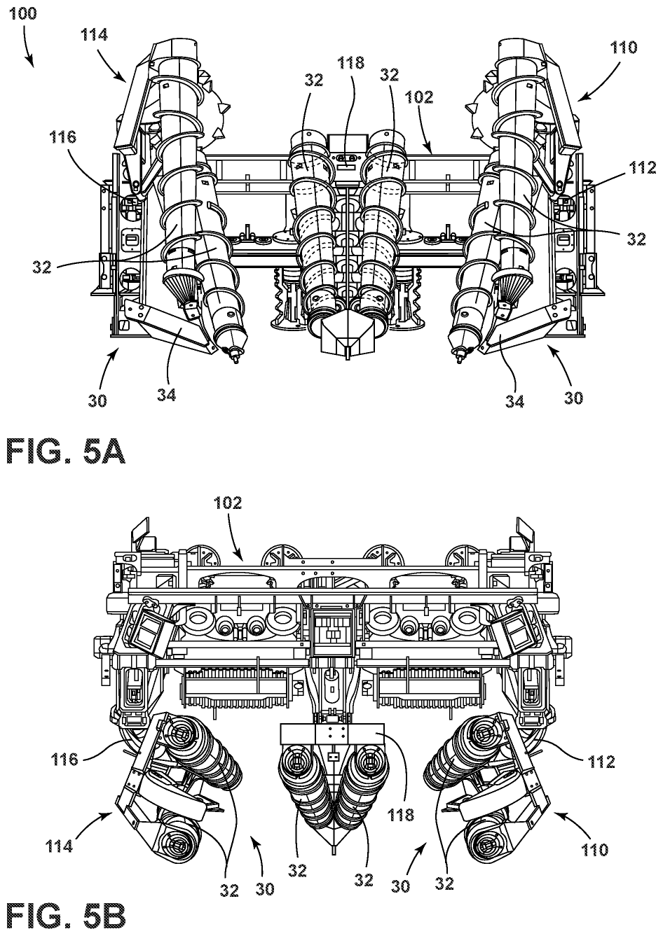

In various examples, the first pivoting frame 110 may be movable between at least a first, operational position, as illustrated in FIG. 2, and a second, storage position, as illustrated in FIG. 5A. In such examples, the one or more central portion feed rollers 32 is a first distance from either one of the pair of feed rollers 32 operably coupled with the first pivoting frame 110 when the first pivoting frame 110 is in the first position. Additionally, the one or more central portion feed rollers 32 is a second, smaller distance from either one of the pair of feed rollers 32 operably coupled with the first pivoting frame 110 when the first pivoting frame 110 is in the second position. As such, the first opening 120 may have a first width when the first pivoting frame 110 is placed in the first, operational position and a second, smaller width when the first pivoting frame 110 is placed in the second, storage position.

In some instances, the second line divider set 30 is positioned on an opposing side of the central portion divider set from the first line divider set 30 and operably coupled with the structural frame 102. The second line divider set 30 can include a pair of feed rollers 32 operably coupled with the second pivoting frame 114. A second opening 122 may be defined between the one or more central portion feed rollers 32 and the feed rollers 32 operably coupled with the second pivoting frame 114 for separation and direction of the crop stalks for harvesting.

In various examples, the second pivoting frame 114 may be movable between at least a first, operational position, as illustrated in FIG. 2, and a second, storage position, as illustrated in FIG. 5A. In such examples, the one or more central portion feed rollers 32 is a first distance from either one of the pair of feed rollers 32 operably coupled with the second pivoting frame 114 when the second pivoting frame 114 is in the first position. Additionally, the one or more central portion feed rollers 32 is a second, smaller distance from either one of the pair of feed rollers 32 operably coupled with the second pivoting frame 114 when the second pivoting frame 114 is in the second position. As such, the second opening 122 may have a first width when the second pivoting frame 114 is placed in the first, operational position and a second, smaller width when the second pivoting frame 114 is placed in the second, storage position.

In various examples, the plates 34 associated with each of the feed rollers 32 within the first line divider set 30 may be configured to move with the first pivoting frame 110 as the first pivoting frame 110 is moved between the first position and the second position. Likewise, the plates 34 associated with each of the feed rollers 32 within the second line divider set 30 may be configured to move with the second pivoting frame 114 as the second pivoting frame 114 is moved between the first position and the second position.

Referring further to FIGS. 2-9B, in the illustrated examples, the first pivoting frame 110 may be operably coupled with the structural frame 102 through a first connection element 112. Similarly, the second pivoting frame 114 may be operably coupled with the structural frame 102 through a second connection element 116. Each of the first connection element 112 and the second connection element 116 may be of any geometry. In addition, the first connection element 112 may be integrally formed with or later attached to the first pivoting frame 110 and/or movable with the first pivoting frame 110. The second connection element 116 may be integrally formed with or later attached to the second pivoting frame 114 and/or movable with the second pivoting frame 114. Additionally or alternatively, the first connection element 112 and/or the second connection element 116 may be integrally formed with or later attached to the structural frame 102 and the first pivoting frame 110 and/or the second pivoting frame 114 may be movable relative to the second connection element 116.

In some instances, the cutting and harvesting assembly 100 can include a locking element, such as a retainer 142, for maintaining the first pivoting frame 110 and/or the second pivoting frame 114 in their respective first, open or second, pivoted positions. In general, the locking elements may each be configured as a mechanical element, an electrical element, a hydraulic element, a pneumatic element, a combination thereof, and/or any other element capable of maintaining the first pivoting frame 110 and/or the second pivoting frame 114 in the chosen position.

Additionally or alternatively, the cutting and harvesting assembly 100 may include actuators that help move the first pivoting frame 110 and/or the second pivoting frame 114 between their respective first, open or second, pivoted positions. In various examples, the actuators may each be configured as a mechanical actuator, an electrical actuator, a hydraulic actuator, a pneumatic actuator, a combination thereof, and/or any other actuator capable of moving the first pivoting frame 110 and/or the second pivoting frame 114 to the chosen position. Additionally or alternatively, the first pivoting frame 110 and/or the second pivoting frame 114 can be moved manually.

In several examples, the cutting and harvesting assembly 100 is mounted directly, or indirectly, on the front structure of the chassis 12 (FIG. 1) of the agricultural machine 10. Optionally, according to another embodiment of the present invention, this cutting and harvesting assembly 100 is mounted on an independent platform arranged to be coupled and uncoupled in the front portion of the structure of said chassis 12 (FIG. 1) of the agricultural machine 10.

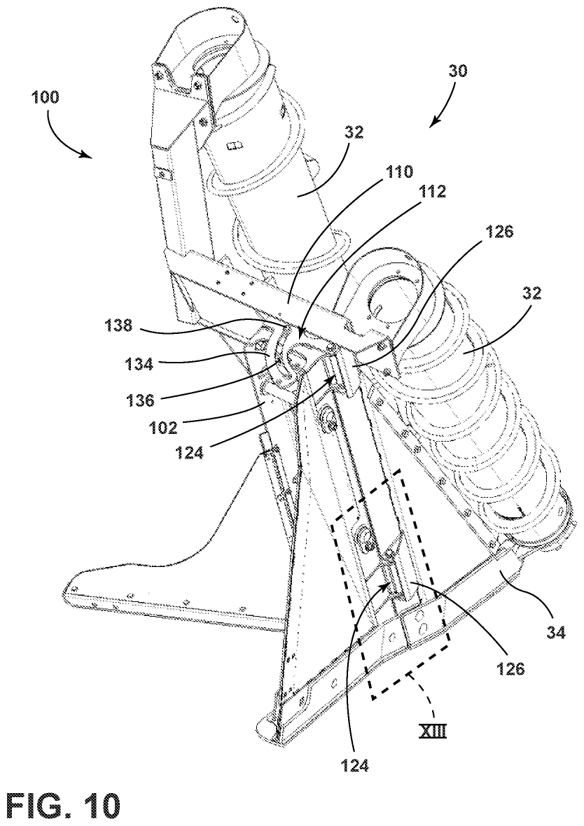

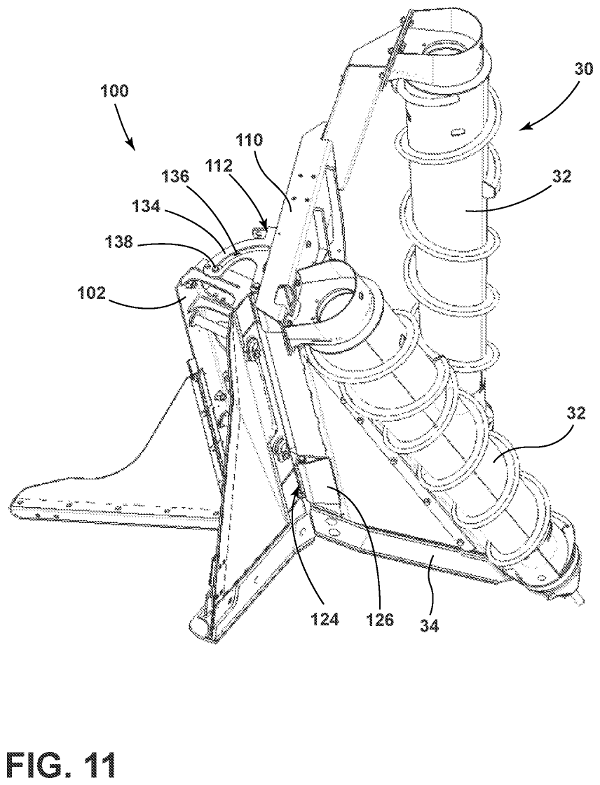

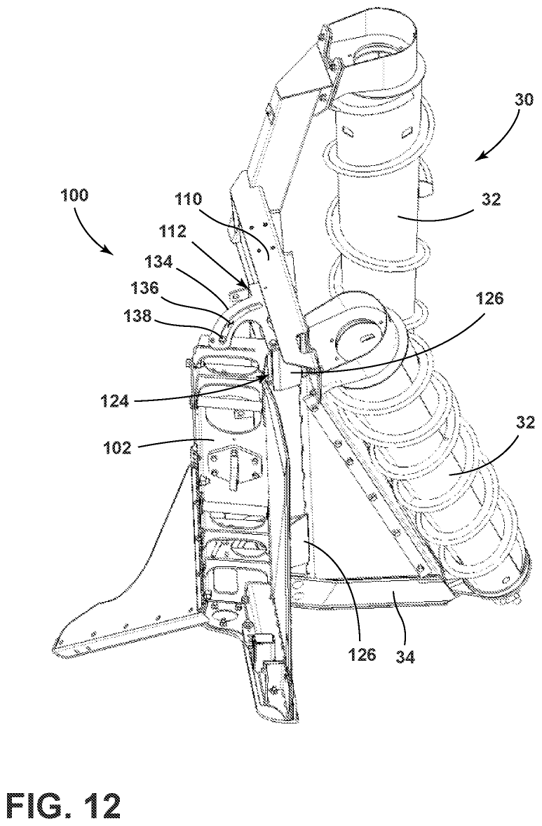

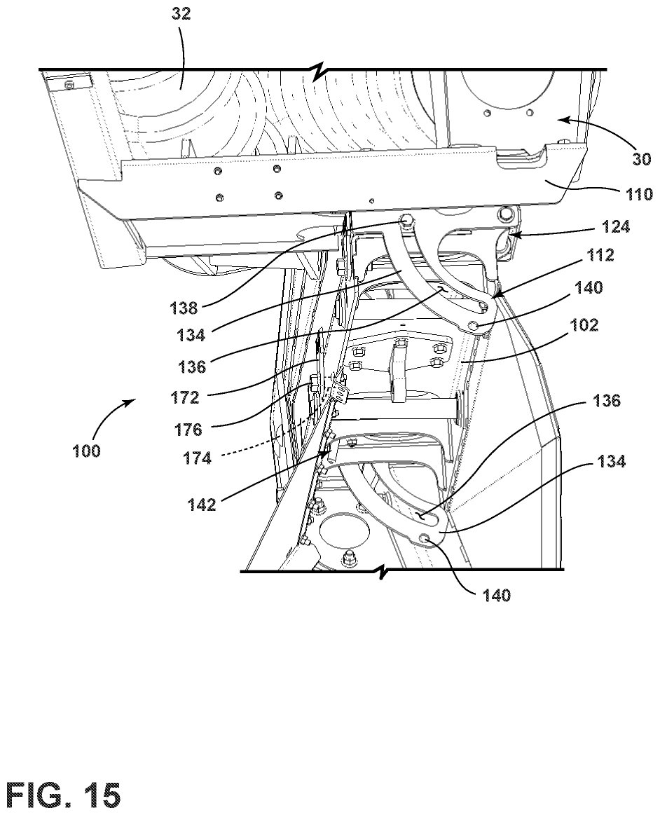

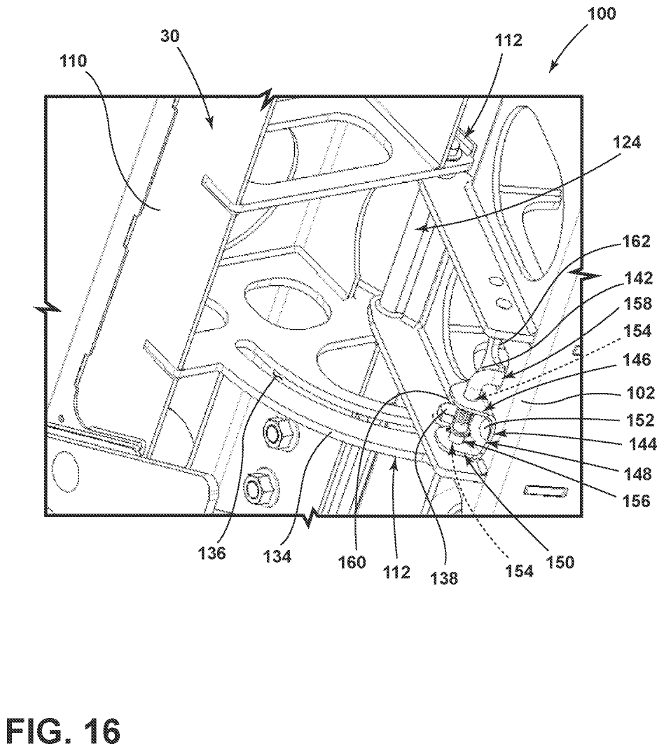

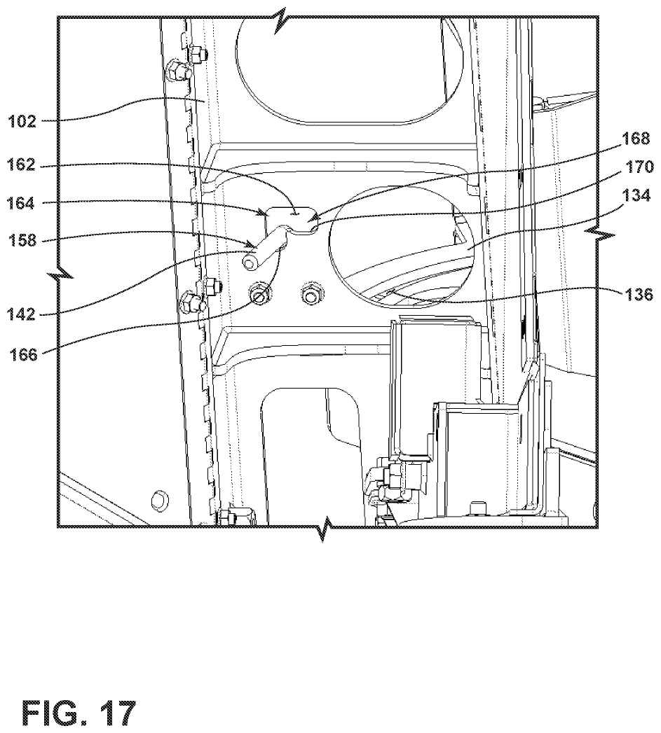

Referring now to FIGS. 10-17, the first line divider set 30 is illustrated according to various aspects of the present disclosure. It will be appreciated that while the first line divider set 30 is described with reference to FIGS. 10-17, the second line divider set 30 may include any of the disclosed features as well. It will further be appreciated that due to the first line divider set 30 being positioned on an opposing side of a vehicle centerline and/or center portion line divider set 30 from the second line divider set 30, the components of the second line divider set 30 may be mirrored from those of the first line divider set 30. In addition, in various examples, the first line divider set 30 may rotate laterally inward in a first direction while the second line divider set 30 may rotate laterally inward in a second direction. The second rotational direction may be generally opposite to the first rotational direction.

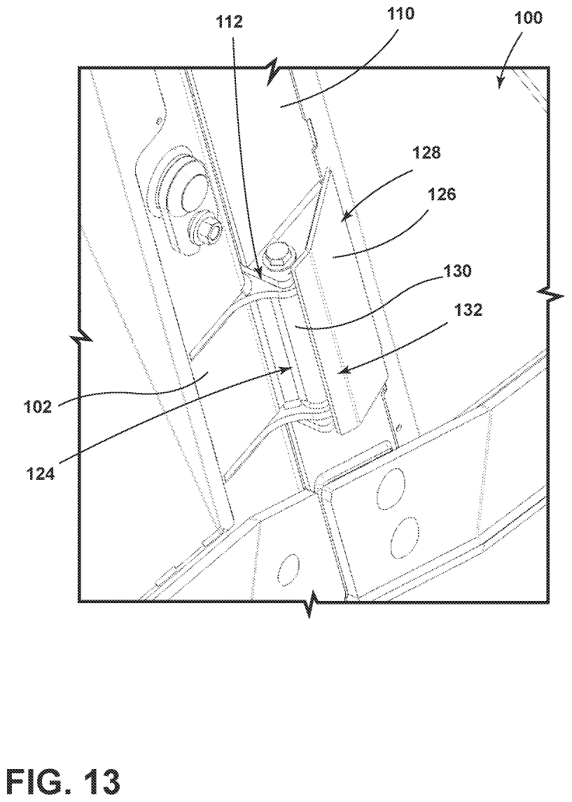

As illustrated, in some examples, the first connection element 112 may include one or more hinges 124 may be operably coupled with the structural frame 102 and the first pivoting frame 110. The one or more hinges 124 may define the rotational axis of the first pivoting frame 110. A hinge shield 126, which is illustrated in greater detail in FIG. 13, may be positioned laterally outward of one or more of the hinges 124 and at least partially cover one or more of the hinges 124. As illustrated, the hinge shield 126 may include a first portion 128 that is positioned at least partially vehicle forward of a hinge pin 130 and a second portion 132 that is vehicle rearward of the first portion 128.

Referring again to FIGS. 10-17, the first connection element 112 may additionally or alternatively include one or more support arms 134 that articulate together with the first pivoting frame 110. Each of the support arms 134 may have any desired geometry, such as a non-linear portion. In addition, the non-linear portion may define a slot 136 therein. A guide 138 may be positioned within the slot 136 and operably coupled with the structural frame 102. In the illustrated examples, the guide 138 is configured as a fastener. However, the guide 138 may be configured as any other structure without departing from the teachings provided herein. While the first pivoting arm is rotated relative to the support frame, the guide 138 may stay within the slot 136 to assist in guiding the first pivoting frame 110 between the first position and the second position, or vice versa. Once the first pivoting frame 110 is placed in the first position and/or the second position, the guide 138 may be tightened to further retain the first pivoting frame 110 in a defined position.

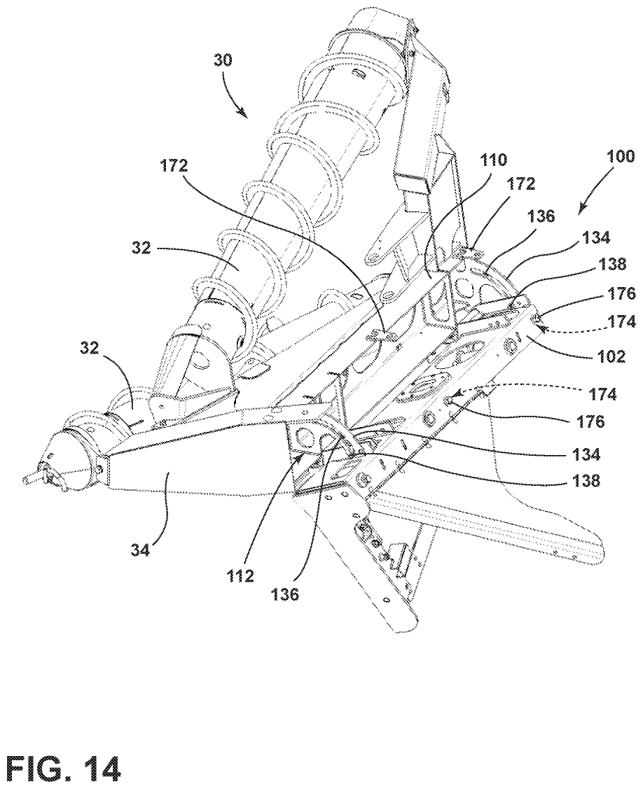

With further reference to FIGS. 14-17, in some examples, the non-linear portion of the first connection element 112 may further define one or more retaining openings 140. In some instances, a retainer 142 may be positioned within the retaining opening 140 to retain the first connection element 112 and, thus, the first pivoting frame 110 in a defined position.

In some instances, the retainer 142 may be positioned in a retainer bracket 144. The retainer bracket 144 may be operably coupled with the structural frame 102. As illustrated, the retainer bracket 144 may include an upper portion 146, an intermediate portion 148, and a bottom portion 150. The intermediate portion 148 may be operably coupled with the structural frame 102, which may be accomplished through one or more fasteners 152 and/or any other fastening method. The upper portion 146 and the bottom portion 150 may extend from the intermediate portion 148 with each defining a retainer void 154. The retainer 142 may extend through each retainer void 154 to align the retainer 142 with the retaining opening 140 when the retaining opening 140 is aligned with the retainer voids 154.

In several examples, a first segment 156 of the retainer 142 may be positioned through the retainer voids 154 and a second segment 158 may be offset from the first segment 156. In some instances, a biasing member 160, such as a spring, may be operably coupled with the first segment 156 of the retainer 142. For instance, the biasing member 160 may be positioned about the retainer 142 at a position between the upper portion 146 and the bottom portion 150 of the retainer bracket 144. The biasing member 160 may be configured to urge the retainer 142 downwardly within the retainer slots defined by the retainer bracket 144.

In various examples, the structural frame 102 may define a retainment hole 162. The second segment 158 of the retainer 142 may extend into the retainment hole 162. As illustrated, the retainment hole 162 may include a first section 164 having a first bottom surface 166 and a second section 168 having a second bottom surface 170. The first bottom surface 166 may be vertically offset from the second bottom surface 170 such that the second segment 158 of the retainer 142 may selectively be retained within the first section 164 and/or the second section 168 through downward force provided by the biasing member 160. Due to the offset heights of the first bottom surface 166 from the second bottom surface 170, the retainer 142 may be positioned within an engaged position when placed in the first section 164 such that the retainer 142 is at least partially positioned within the slot 136 of the first connection element 112. The retainer 142 may alternatively be positioned within a disengaged position when placed in the second section 168 such that the retainer 142 is positioned above the slot 136 of the first connection element 112 thereby allowing for the first connection element 112 and the first pivoting frame 110 to rotate.

Referring still to FIGS. 14-17, in various examples, a locking bracket 172 may be integrally formed with and/or later attached to the first pivoting frame 110. In addition, the structural frame 102 may define a locking hole 174. In use, when the first pivoting frame 110 is moved to the first, open position, a void defined by the bracket may align with the locking hole 174. Once aligned, a fastener 176 may be positioned through the void and the locking hole 174 for retaining the first line divider set 30 in the first position. In such examples, the locking holes 174 may couple with the locking bracket 172 to retain the first pivoting arm in the first position and the retaining holes may be used to retain the first pivoting arm in the second position.

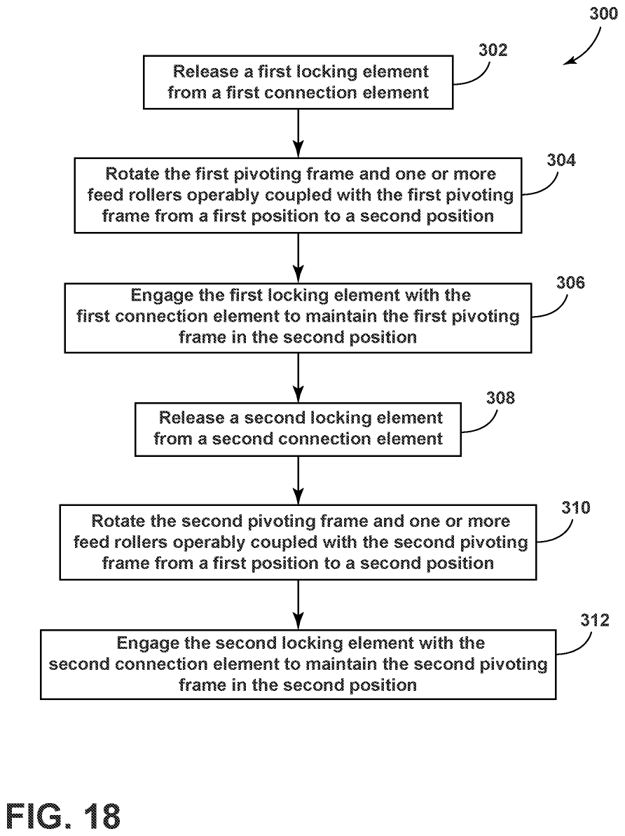

Referring now to FIG. 18, a method 300 for operating a cutting and harvesting assembly for an agricultural machine is illustrated in accordance with aspects of the present subject matter. In general, the method 300 will be described herein with reference to the agricultural machine 10 and the cutting and harvesting assembly 100 described above with reference to FIGS. 1-17. However, the disclosed method 300 may generally be utilized with any suitable cutting and harvesting assembly. In addition, although FIG. 18 depicts steps performed in a particular order for purposes of illustration and discussion, the methods discussed herein are not limited to any particular order or arrangement. One skilled in the art, using the disclosure provided herein, will appreciate that various steps of the methods disclosed herein can be omitted, rearranged, combined, and/or adapted in various ways without deviating from the scope of the present disclosure.

As shown in FIG. 18, at (302), the method 300 can include releasing a first locking element from a first connection element. The first connection element operably couples a first pivoting frame of the harvesting assembly to a structural frame of the harvesting assembly. In some instances, releasing the first locking element from the first connection element can include removing a retainer from a locking aperture defined by the connection element.

At (304), the method 300 can include rotating the first pivoting frame and one or more feed rollers operably coupled with the first pivoting frame from a first position to a second position. The rotation of the first pivoting frame relative to the structural frame may be guided by sliding the first pivoting arm and the first connection element along a guide that is positioned within the one or more retaining openings defined by the first connection element and/or by utilizing a hinge for rotational movement of the first pivoting arm and the first connection element about a defined axis.

At (306), the method 300 can include engaging the first locking element with the first connection element to maintain the first pivoting frame in the second position.

At (308), the method 300 can include releasing a second locking element from a second connection element. The second connection element operably couples a second pivoting frame of the harvesting assembly to the structural frame of the harvesting assembly. In some instances, the first pivoting frame is laterally offset from the second pivoting frame along the structural frame.

At (310), the method 300 can include rotating the second pivoting frame and one or more feed rollers operably coupled with the second pivoting frame from a first position to a second position. The rotation of the second pivoting frame relative to the structural frame may be guided by sliding the second pivoting arm and the second connection element along a guide that is positioned within the one or more retaining openings defined by the second connection element and/or by utilizing a hinge for rotational movement of the second pivoting arm and the second connection element about a defined axis.

At (312), the method 300 can include engaging the second locking element with the second connection element to maintain the second pivoting frame in the second position.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A cutting and harvesting assembly for an agricultural machine, the assembly comprising:
a structural frame;
a central portion divider set operably coupled with the structural frame and including one or more central portion feed rollers;
a first line divider set laterally offset from the central portion divider set and operably coupled with the structural frame, the first line divider set comprising:
a first pivoting frame;
a first connection element operably coupled to the first pivoting frame and the structural frame;
one or more first set feed rollers operably coupled with the first pivoting frame; and
a second line divider set positioned on an opposing side of the central portion divider set from the first line divider set and operably coupled with the structural frame, the second line divider set comprising:
a second pivoting frame;
a second connection element operably coupled to the second pivoting frame and the structural frame; and
one or more second set feed rollers operably coupled with the second pivoting frame.

2. The cutting and harvesting assembly of claim 1, wherein the first pivoting frame further includes a first locking element for maintaining the first pivoting frame in a first position or a second position, and wherein the second pivoting frame further includes a second locking element for maintaining the second pivoting frame in a first position or a second position.

3. The cutting and harvesting assembly of claim 2, wherein the first locking element and the second locking element are each configured as at least one of a mechanical element, an electrical element, a hydraulic element, a pneumatic element, or a combination thereof.

4. The cutting and harvesting assembly of claim 1, further comprising:
a first drive actuator operably coupled with the pivoting frame for assisting in moving the first pivoting frame between the first position and the second position.

5. The cutting and harvesting assembly of claim 4, wherein the first drive actuator is at least one of a mechanical actuator, an electrical actuator, a hydraulic actuator, a pneumatic actuator, or a combination thereof.

6. The cutting and harvesting assembly of claim 1, wherein the first connection element articulates with the first pivoting frame, and wherein the second connection element articulates with the second pivoting frame.

7. The cutting and harvesting assembly of claim 1, wherein the central portion divider set further includes a central portion frame supporting the one or more central portion feed rollers, and wherein the central portion frame is operably coupled with the structural frame.

8. The cutting and harvesting assembly of claim 1, wherein the structural frame forms part of a chassis of the agricultural machine.

9. The cutting and harvesting assembly of claim 1, wherein the structural frame is configured as an independent platform and arranged to be coupled and uncoupled from a chassis of the agricultural machine.

10. A cutting and harvesting assembly for an agricultural machine, the assembly comprising:
a structural frame;
a line divider set operably coupled with the structural frame, the line divider set comprising:
a pivoting frame;
a connection element operably coupled to the pivoting frame and the structural frame, the connection element configured to maintain the pivoting frame in a first position and a second position;
a first feed roller operably coupled with the pivoting frame; and
a second feed roller separated from the first pivoting frame and operably coupled with the structural frame, wherein the first feed roller is a first distance from the second roller when the pivoting frame is in the first position and the second feed roller is a second, smaller distance from the second roller when the pivoting frame is in the second position.

11. The cutting and harvesting assembly of claim 10, wherein the connection element includes a support arm defining one or more retaining openings.

12. The cutting and harvesting assembly of claim 11, wherein a guide is positioned within the one or more retaining openings and operably coupled with the structural frame.

13. The cutting and harvesting assembly of claim 10, further comprising:
a retainer positioned within a retainer bracket and removably couplable with the connection element, wherein the retainer bracket is operably coupled with the structural frame.

14. The cutting and harvesting assembly of claim 13, wherein the retainer is positioned through one or more retainer voids defined by the retainer bracket, and wherein the retainer is configured to be selectively disposed within a retaining opening defined by the support arm.

15. The cutting and harvesting assembly of claim 13, wherein the structural frame defines a retainment opening, and wherein a segment of the retainer is positioned within the retainment opening.

16. A method for operating a cutting and harvesting assembly for an agricultural machine, the method comprising:
releasing a first locking element from a first connection element, wherein the first connection element operably couples a first pivoting frame of the harvesting assembly to a structural frame of the harvesting assembly; and
rotating the first pivoting frame and one or more feed rollers operably coupled with the first pivoting frame from a first position to a second position.

17. The method of claim 16, further comprising:
engaging the first locking element with the first connection element to maintain the first pivoting frame in the second position.

18. The method of claim 16, wherein releasing the first locking element from the first connection element further comprises removing a retainer from a locking aperture defined by the connection element.

19. The method of claim 16, further comprising:
releasing a second locking element from a second connection element, wherein the second connection element operably couples a second pivoting frame of the harvesting assembly to the structural frame of the harvesting assembly, and wherein the first pivoting frame is laterally offset from the second pivoting frame along the structural frame; and
rotating the second pivoting frame and one or more feed rollers operably coupled with the second pivoting frame from a first position to a second position.

20. The method of claim 19, further comprising:
engaging the second locking element with the second connection element to maintain the second pivoting frame in the second position.
